(19) United States
(12) Patent Application Publication
(10) Pub. No.: US 2013/0340316 A1
(43) Pub. Date: Dec. 26, 2013

(54) FLOAT LINE HAVING A CLUTCHED BRAKING CAPABILITY

(71) Applicant: Joshua Alexander Gregory, Belmont, CA (US)

(72) Inventor: Joshua Alexander Gregory, Belmont, CA (US)

(21) Appl. No.: 13/531,490

(22) Filed: Jun. 22, 2012

(51) Int. Cl. A01K 81/06; B23P 11/00

(52) U.S. Cl. 43/4; 29/433

(57) ABSTRACT

Integrated float line assemblies having braking capability and methods for forming same are disclosed. The integrated float line assembly includes a braided portion slidably captured between the two ends of a float line, wherein the float line can slide along an interior hollow of the braided portion and be selectively braked by engaging the braided portion. The braided portion is provided with substantially rigid end ferrules. Obstruction having a transverse dimension larger than an inner diameter of the ferrule is provided with at least one end of the float line to prevent the braided portion from being separated from the float line.

### BACKGROUND OF THE INVENTION

The present invention relates to apparatus for fishing. More particularly, the present invention relates to methods and apparatus for retrieving fish that has been speared.

Spearfishing is a growing sport. Spearfishing involves a diver submerging underwater, either on his own lung power or through some artificial breathing apparatus (such as SCUBA) and uses a speargun or sling or polespear to impale a fish with a sharpened shaft. Although there are many aspects to spearfishing, one branch of the sport involves hunting powerful fish (defined herein as any fish that is capable of taking a spearfisherman's spear and escaping if not tethered or restrained in some manner). For such an endeavor, the shalt is usually barbed or tipped with a sliptip. After the fish is impaled, the fish is permitted to run free to tire out while trailing the shaft. The spearfisherman uses a float line, which is connected to the shaft, to retrieve the fish. In some cases, the shaft is directly connected to the float line (as in the case with some polespears). In other cases, the shaft is connected to a shooting line, which is connected to the float line. In other cases, the shaft may be connected to the shooting line, which is connected to the speargun and which in turn is connected to the float line. After the fish is allowed to run for some time and/or the spearfisherman has recovered sufficiently to begin retrieval, the spearfisherman may begin to pull on the float line to retrieve the fish.

FIGS. 1A and 1B show a conventional spearfishing arrangement involving a float line connected to the shooting line of a spear of a typical speargun. In FIGS. 1A and 1B, speargun 102 is employed to propel a spear 104 having a sliptip 106 toward a fish for the purpose of impaling the fish with spear 104. Spear 104 is connected to a shooting line 108, which is part of the speargun's rigging. Shooting line 108, which is typically made of a high strength mono fishing line or a stainless steel cable is connected to a float line 110 at float line end 112. Float line end 114 may be left unconnected or may be connected to a float (116).

Float lines may be as simple as a length of suitable rope, typically between 20 feet and 200 feet in length. The more sophisticated float lines employs polyethylene tubing, which is buoyant, slippery and resistant to kinking and knot-forming. The polyethylene tubing may be hollow and reinforced with a rope or line in its core. For example, a high-strength synthetic line (such as Spectra) may be employed to reinforce the polyethylene tubing.

FIG. 2 shows a typical float line 200 having a synthetic core rope 202, and an outer sheath of polyethylene tubing 204, and two end plugs 206 and 208. End plugs 206 and 208 serve as the mechanical sites to fasten core rope 202 with outer sheath 204 and also serve as terminals for connecting float line 200 to the shooting line or to the float, as mentioned earlier. In the design of float line 200, strength is necessary since many fish are powerful fighters capable of exerting great shock force (and often breaking force) on the float line, particularly during the initial nm.

The retrieval of a powerful fish is one of the most dangerous events in a spearfisheman's day. A powerful fish has the ability to sound deeply, pulling down the spearfisheman to drown if the spearfisherman refuses to let go of the float line or is tangled in the float line. For this reason, the float line is often connected to one or more floats. If the fish pulls hard, the spearfisherman can let go of the float line and let the buoyancy of the float wear out the fish. Once the fish begins to tire, the spearfisherman may resume retrieval from the surface.

Spearfishermen wants to retrieve their fish quickly. The spearfishing environment often involves strong current, deep water, and sharks. The latter will be attracted to a wounded and bleeding fish and will endanger the lives of the spearfisherman if excited by the sight and smell of a bleeding fish. For this reason, the rapid retrieval of the impaled fish is an important consideration for spearfishermen. Further, retrieval of a fish is often done at the surface where the diver is exposed to current, waves, and other boats. If the diver is exhausted from the prolonged effort, the diver is susceptible to fatigue and errors, some of which may be fatal when a large fish, heavy current, and busy boat traffic are involved.

As mentioned, landing a powerful but wounded fish is a dangerous task. The fish may be retrieved to the point where it is near the surface and it may sound again upon regaining strength or upon being frightened by the sight of the spearfisherman or his float. It is not unusual for a spearfisherman to repeatedly pull up a fish from a great depth only to have to let out float line when the fish wishes to run again. The spearfisherman must also be careful, with some species, to not let the fish reach the bottom to hole up in a deep cave. For example, the spearfisherman may pull against the float line when the fish sounds for the bottom to wear out the fish or to prevent the fish from reaching caves on the ocean floor. However, every additional minute spent recovering a wounded fish increases the danger of shark attack, entanglement, and fatigue. For this reason, devices that may assist the spearfisherman in reducing the amount of effort and the time required to land a fish is highly desirable from a safety and convenience standpoint.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B show a conventional spearfishing arrangement involving a float line connected to the shooting line of a spear of a typical speargun.

FIG. 2 shows a typical float line having two end plugs, a synthetic core rope, and an outer sheath of polyethylene tubing.

FIG. 3 shows, in accordance with an embodiment of the present invention, an improved float line having a braided hollow core brake.

FIG. 4 shows, in accordance with an embodiment of the present invention, another improved float line having a braided hollow core brake.

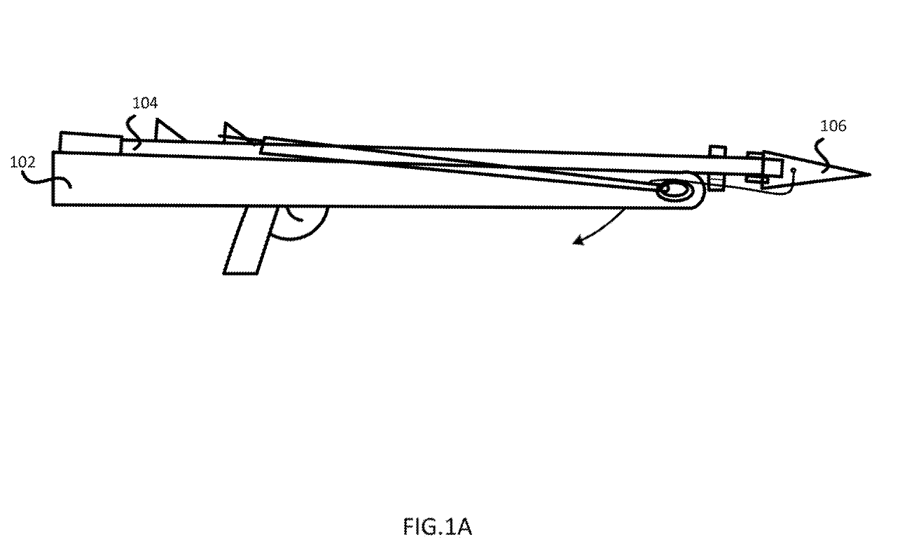

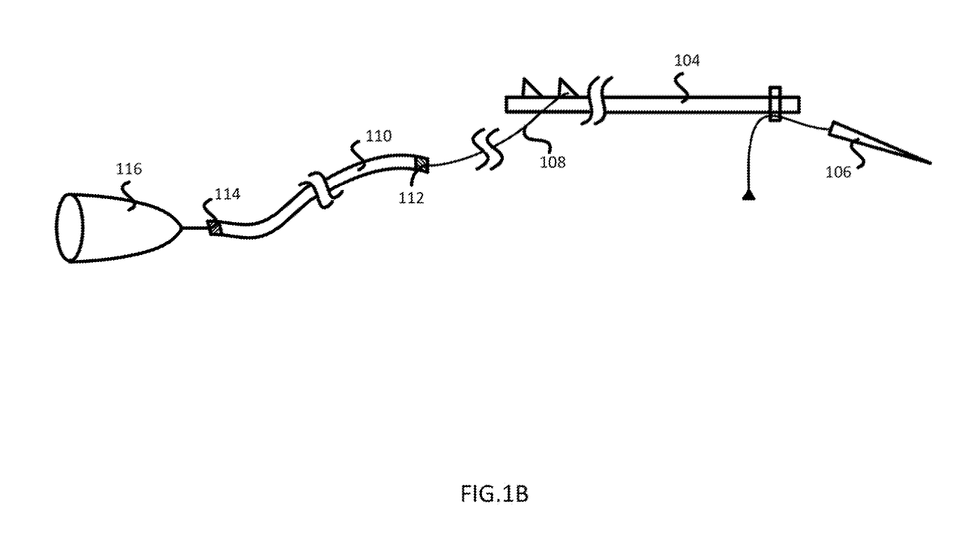

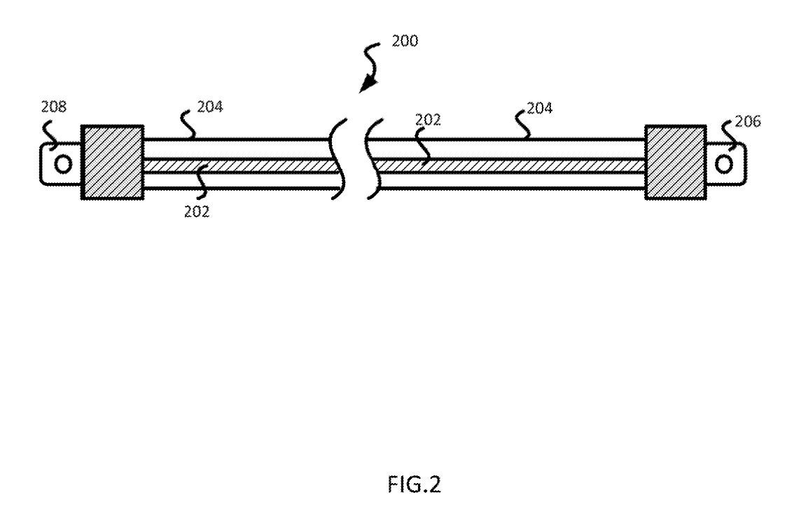

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

As mentioned, the repeated cycles of fish retrieval and fish runs are typical during the landing of a large and powerful fish. These runs are beneficial as they wear out the fish over time, but an unduly long time spent landing a fish increases the chance that sharks may be attracted to the area, that the spearfisherman may be fatigued, and that the fish may be able to find a cave to hole up, resulting in a lost fish or a dangerous underwater retrieval mission. For this reason, a spearfisherman often tries to limit the amount of float line the fish is permitted to regain during each run. In other words, as the fish is pulled toward the spearfisherman (often at the surface), the amount of float line between the fish and the spearfisherman (or the float) is shortened. Keeping this float line short during a subsequent run (by paying out little or none of the retrieved float line) forces the fish to fight the float's buoyancy, which wears the fish out faster. Keeping this float line short also renders it less likely that the fish can reach the bottom to foul in one of the underwater structures.

In the past, the task of keeping this float line short during a landing attempt belongs to the spearfisherman. The spearfisherman literally grips the float line and tries to use his strength/buoyancy against the fish to keep the fish from regaining float line during a subsequent run. For relatively small fish (e.g., 20-40 lbs), such an approach is possible. For larger fish, it has been found that the average human lacks strength and leverage in the water to stop a large fish (e.g., a 100-lb pelagic fish) from ripping the float line out from the spearfisherman's grip and from diving as deep as the length of the float line would allow until stopped by the float. When this happens, the spearfisherman now has to work hard to pull up the fish again from a great depth.

In accordance with an aspect of the invention, the braided hollow core brake assembly is integrated with the float line. The braided hollow core brake assembly is configured to permit easy retrieval of float line when pulling the fish toward the spearfisherman. If the fish starts to nm, the brake function of the braided hollow core brake assembly can be easily activated by the spearfisherman to retard or stop the fish from taking float line. In embodiments of the invention, the braided hollow core brake assembly is made of a corrosion-resistant braid material that is designed to provide years of reliable service in the aquatic and/or ocean conditions.

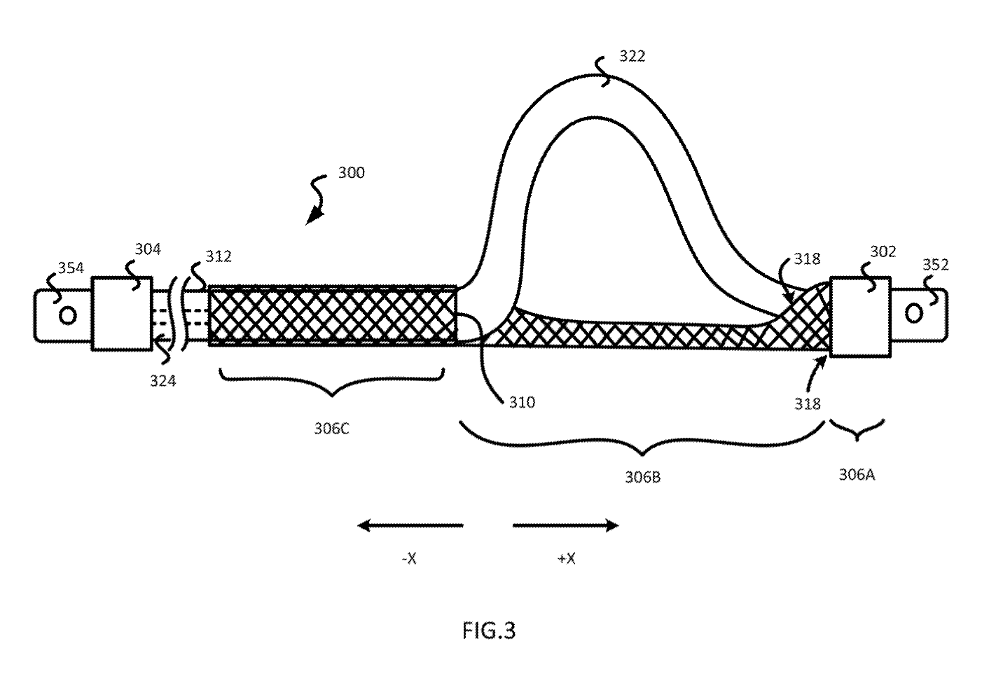

FIG. 3 shows, in accordance with an embodiment of the present invention, an improved float line having an integrated hollow core brake. As seen in FIG. 3, an integrated brake-enabled float line assembly 300, including float line 322 having two ends 302 and 304 is shown. Float line 322 is preferably a substantially smooth tube-shaped construct, which may be solid or hollow. If a hollow float line is chosen, the interior of the float line may be reinforced with a core rope or string to add strength. In an embodiment, float line 322 is made of PVC tubing having an outer diameter of about ⅜″ and an inner diameter of ¼″, thereby having a hollow interior portion that is capable of accommodating a synthetic line 324 such as a spectra line for strength. Other types of high strength lines may also employed to provide strength at the core. The tubing is available from a variety of sources, including for example US Plastics Corporation of Lima, Ohio. Other tubing materials such as polyethylene and polyurethane in the same or other outer/inner diameters may also be employed. A plug 352 is coupled to end 302 while a plug 354 is coupled to end 304 as shown. A portion of the plug may be inserted into the tubing and a mechanical connection may be made (such as by tying) between the plug and the core line. The plug is then connected to the tubing material, in an embodiment. These plug serve as the mechanical coupling site for the tubing and the reinforcing core, as well as serving as terminals for connecting float line 322 to other devices such as the shooting line of the spear, the float, etc.

A braided hollow core brake assembly having a connecting portion 306A, a belly portion 306B, and a grip portion 306C is shown. Generally speaking, the braided hollow core brake assembly is of a braided hollow core construction. That is, multiple strands of materials are braided into a tube-form. In a preferred embodiment, the braided hollow core brake assembly is a polypropylene hollow braid. Connecting portion 306A serves as the portion for connecting the braided hollow core brake assembly and float line 322. Grip portion 306C represents the portion of the braided hollow core brake assembly that is disposed around float line 322. That is, float line 322 is disposed in the hollow core portion of grip portion 306C. As can be seen in FIG. 3, float line 322 enters an end 310 and exits through an opening in the braid material at opening 312. The portion between end 310 and opening 312 represents grip portion 306C. One skilled in the art can appreciate that portions 306A, 306B, and 306C may be constructed, in an embodiment, out of a single length of hollow braid tubing with two opening created through its side.

Generally speaking, the inner and outer surface of grip portion 306C, being of a braided construction, will feel rougher to the touch than the smoother outer surface of the tubing material of float line 322 (which is not of a braided construction). As will be discussed later herein, the gripping action of the braided material on the outer surface of the tubing material of float line 322 when the float line is pulled in one direction provides the braking function. The braided material relaxes when the float line is pulled in an opposite direction, allowing the float line to slide inside the hollow core of the braided hollow core brake assembly. As such, a clutched braking function is provided. Within these constraints, many different types of tubing may be employed for the float line, and many different types of hollow braids and/or braid materials may be employed.

Belly portion 306B extends from opening 312 to the beginning of connecting portion 306A. In an embodiment, connecting portion 306A is disposed around float line 322. That is, float line 322 is disposed in the hollow core portion of connecting portion 306A. In this case, float line 322 exits through an opening 318 and reenters the hollow core of the braided hollow core brake assembly at opening 310. Connecting portion 306A is then fastened (using, for example, suitable tying line and a suitable knot such as a constrictor knot or double constrictor knot or a metal crimp) The connection between connecting portion 306A and float line 322 is made at the vicinity of plug 352 to take advantage of the mechanical support provided by plug 352.

In another embodiment, the connection portion 306A is placed adjacent to a portion of float line 322. In this case, end 302 of float line 322 lays parallel with connecting portion 306A and coupled with connecting portion 306A (using, for example, suitable tying line and a suitable knot such as a constrictor knot or double constrictor knot or a metal crimp) The connection between connecting portion 306A and float line 322 is made at the vicinity of plug 352 to take advantage of the mechanical support provided by plug 352. Float line 322 then enters the hollow core of the braided hollow core brake assembly at opening 310.

Generally speaking, the inner diameter of the braided hollow core brake assembly is chosen such that when the braid of grip portion 306C is bunched up (i.e., longitudinally shortened), the inner diameter of grip portion 306C expands to be greater than the outer diameter of float line 306. In this manlier, when the braid of the braided hollow core brake assembly is bunched up, float line 322 can freely slide through the braided hollow core brake assembly. This state is called the retrieve state and typically exists when float line 322 is pulled in the direction +X through opening 312. In use, the spearfisherman simply holds grip portion 306C lightly in one hand to permit float line 322 to be grabbed at the portion between opening 310 and opening 318 and pulled toward the spearfisherman body. With reference to FIG. 3, the user may grab grip portion 306c lightly with one hand and the float line at the portion between opening 310 and opening 318 (such as at location indicated by reference number 322) and pulls on the float line in the +X direction to retrieve the float line. The movement of float line 322 in the +X direction tends to loosen or bunch up grip portion 306C, causing the inner diameter of the braid at grip portion 306C to expand, thereby allowing float line 322 to slide in the direction +X through opening 312 and out of opening 310.

When the fish wishes to run, the movement of float line 322 in the −X direction tends to cause the fibers or grip portion 306C to move in the direction −X. Since one end of the braided hollow core brake assembly is fastened (at connecting portion 306A, a portion of which is hidden by the connector covering of connector 302) with float line 322 at plug 352, which in turn tends to be connected to a float, for example, these braided fibers or grip portion 306C stretches in the −X direction and tightens up the inner diameter of grip portion 306C. The tightening of the inner diameter of grip portion 306C causes the braided hollow core brake assembly to tightly grip float line 322. A braking function is thus activated. If desired, the spearfisherman can assist in the activation of the brake by manually elongating grip portion 306C (such as by grabbing grip portion 306C and pull in the direction −X to cause elongation and narrowing of the inner diameter of grip portion 306C). The harder the float line is pulled in the −X direction, the tighter the grip provided by grip portion 306C.

If plug 352 of float line 322 is connected to a float, the brake function provided by the braided hollow core brake assembly prevents the fish from regaining the float line that the spearfisherman has pulled through openings 312 and 310 of the braided hollow core brake assembly. In this situation, the belly portion 306B may be taut, and the force exerted by the fish is exerted against float line 322, which is now locked to grip portion 306C, which is in turn connected to belly portion 306B and connecting portion 306A, which is in turn connected to plug 352 and to a float (or another object). The fish thus essentially fights against the buoyancy of the float and wears itself out without requiring much additional effort on the part of the spearfisherman. Even if the float is not employed, the spearfisherman can simply grip belly portion 306B while resting on the surface to wear out the fish below. When belly portion 306B is gripped by the spearfisherman and there is a force on the float line 322 in the −X direction (such as the force exerted by a pulling fish), the fish cannot take additional float line away from the spearfisherman since grip portion 306C tightly grips the float line in this case.

In accordance with an embodiment of the invention, a method for manufacturing the innovative float line having integrated hollow core brake is provided. Some of the steps described may be performed in different orders as described if desired. First, a resilient and/or flexible float line having a tube shape and having a substantially smooth outer cover is provided. As mentioned, ⅜″ PVC tubing works well in an embodiment. The tubular float line may be provided with an inner core of high strength material if desired. Next, the braided hollow core brake assembly having a connecting portion, a belly portion, and a grip portion is provided. Next, the connecting portion is coupled to the float line in a non-sliding manner. Next, one end of the float line is fed through an opening (such as opening 310 of the example of FIG. 3) in the braided hollow core brake assembly and exits through another opening of the braided hollow core brake assembly. Next, the float line end that is inserted into the opening in the braided hollow core brake assembly is permitted to traverse the hollow interior of the braided hollow core brake assembly to exit through end 310. An integrated float line having brake capability is thus formed.

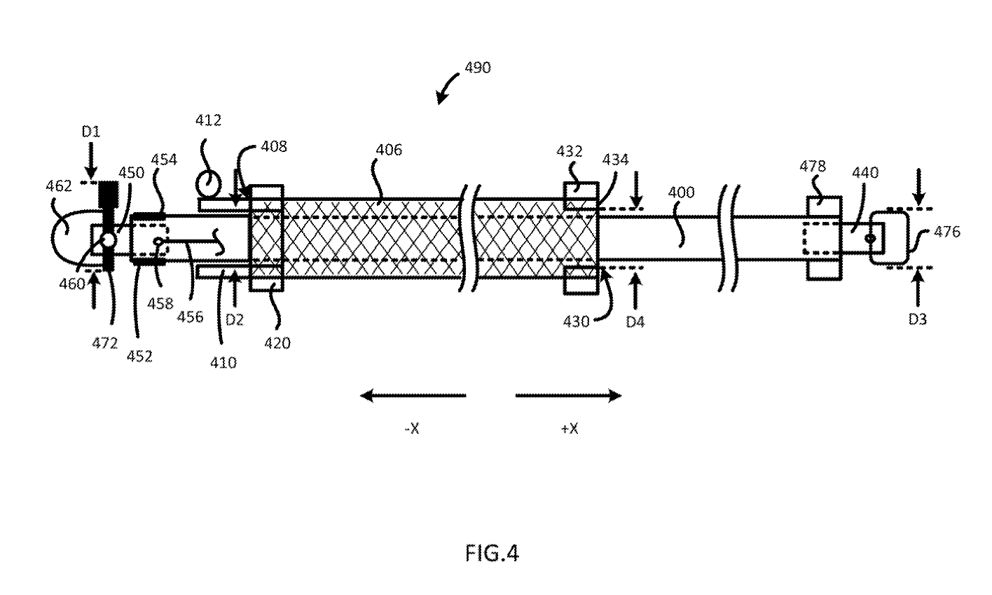

FIG. 4 shows, in accordance with an embodiment of the present invention, another improved float line having an integrated hollow core braided brake. An integrated brake-enabled float line, assembly 490 includes a float line 400. Float line 400 is preferably a substantially smooth, tube-shaped construct, which may be solid or hollow. If a hollow float line is chosen, the interior of the float line may be reinforced with a core rope or line (such as a high strength synthetic line) to add strength.

In an embodiment, float line 400 is made of PVC tubing having an outer diameter of about ⅜″ and an inner diameter of ¼″, thereby having a hollow interior portion that is capable of accommodating a synthetic line such as a spectra line for strength. The dimensions are only exemplary and other dimensions are possible. Other types of high strength lines may also employed to provide strength at the core. The tubing is available from a variety of sources, including for example US Plastics Corporation of Lima, Ohio. Other tubing materials such as polyethylene and polyurethane in the same or other outer/inner diameters may also be employed. Float line 400 may also be solid (i.e., not hollow) if desired. Float line 400 may also represent a single-strand or multi-strand rope if desired.

Each end of float line 400 may be coupled to a plug (which may be made of metal such as stainless steel or plastic) in the manner discussed earlier. A portion of the plug may be inserted into the tubing, and a mechanical connection may be made (such as by tying using an appropriate line/knot or by using a clip or a connector or other types of connection between a line and a plug) between the plug and the core line. The plug may have a through hole formed in a direction that is transverse to the axis of the cylindrical plug or other features to facilitate the above-mentioned mechanical connection with the reinforcing line.

The plug is then connected to the tubing material, with the reinforcing line disposed inside the tubing, in an embodiment. For example, an appropriate knot such as a constrictor knot or a double constrictor knot may be used to cinch down on the tubing material while the plug is inserted in the tubing end, thus capturing the tubing material between the string loops and the plug. These plugs serve as the mechanical coupling site for the tubing and the reinforcing core, as well as serving as terminals for connecting float line 400 to other devices such as the shooting line of the spear, the float, etc. Alternatively, a compression ring or compression circular clamp may be employed for coupling the plug to the tubing end.

In the example of FIG. 4, plug 450 is shown inserted into end 452 of float line 400, and a mechanical connection 454 (such as a constrictor knot with an appropriate string or a metal or plastic compression clamp) is shown coupling the wall material of float line 400 to the portion of plug 450 that is inserted into end 452 of float line 400. A portion of reinforcing line 456 is shown coupled to a hole 458 of plug 450. Another through hole 460 formed in a direction that is transverse to the axis of the cylindrical plug 450 is shown.

A connector in the form of for example a clip or a ring or a shackle or an obstruction structure (such as a stud or pin) provides a transverse obstruction 472 having a transverse obstruction dimension D1 that is larger than the inner diameter D2 of a substantially rigid ferrule 410. Ferrule 410 may be made out of metal such as stainless steel or plastic, for example. The connector is not as essential as the transverse obstruction 472 in the operation assembly 490, as will be discussed later herein. Further, the relationship between dimensions D1 and D2, as well as ferrule 410, will also be discussed later herein.

A braided hollow core brake assembly having a braided portion 406 is shown. Generally speaking, the braided portion 406 is of a braided hollow core construction. That is, multiple strands of materials are braided into a tube-form. In a preferred embodiment, the braided portion 406 is a polypropylene hollow braid although other suitable materials may also be employed.

One end 408 of braided portion 406 is coupled to a ferrule 410. Ferrule 410 has a general cylindrical shape and has an inner diameter D1 that is substantially larger than the outer diameter of float line 400 to allow float line 400 to freely slide through the cylindrical interior of ferrule 410. Ferrule 410 is fixedly coupled to end 408 such that a through passage is created through the cylindrical interior of ferrule 410 and the interior of braided portion 406. For example, ferrule 410 may be inserted into the hollow interior of braided portion 406 such that a portion of ferrule 410 is inside the hollow interior of braided portion 406.

A compression ring 420, representing a mechanical coupling, may be employed to trap the braided material of braided portion 406 between the interior cylindrical surface of ring 420 and the outer cylindrical surface of ferrule 410 to secure ferrule 410 to end 408 of braided portion 406. Other mechanical couplings (such as for example using string and an appropriate knot including for example a constrictor knot or double constrictor knot) may also be employed to couple end 408 of braided portion 406 to ferrule 410. An attachment structure 412 is provided on ferrule 410 to serve as an attachment point for securing ferrule 410 to, for example, a float or a boat or a clip for ease of handling by hand. In an embodiment, attachment structure 412 is a loop. In an embodiment, attachment structure 412 is a metal enclosed loop (which may be circular or semi-circular or may have other shapes) welded onto ferrule 410.

End 430 of braided portion 406 may be left unattached to a ferrule/coupling combination or, more preferably, may be attached to a ferrule/coupling combination 434/432. Ferrule 434 may also be made of metal such as stainless steel or plastic, for example.

As shown, float line 400 is disposed through ferrule 410 at opening 408, through the entire interior portion of braided portion 406 and out of opening 430 of braided portion 406. Thus the embodiment of FIG. 4 differs from the embodiment of FIG. 3 in that braided portion 406 is continuous, and float line 400 is inserted through the entirety of braided portion 406 from opening 408 to opening 430 in FIG. 4.

Generally speaking, braided portion 406, being of a hollow braided construction, will feel rougher to the touch than the smoother outer surface of float line 400 (which is not of a braided construction). As will be discussed later herein, the gripping action of the braided material on the outer surface of float line 400 when ferrule 410 is pulled in one direction (i.e., the −X direction in FIG. 4) relative to float line 400 provides the braking function. The braided material relaxes when ferrule 410 is pushed in an opposite direction (i.e., the +X direction in FIG. 4) relative to float line 400, thereby enlarging the inner diameter of braided portion 405 and allowing the float line 400 to slide inside the hollow core of the braided hollow core brake assembly. As such, a clutched braking function is provided. Within these constraints, many different types of tubing may be employed for the float line, and many different types of hollow braids and/or braid materials may be employed.

Generally speaking, the inner diameter of the braided portion 406 of the braided hollow core brake assembly is chosen such that when braided portion 406 is bunched up (e.g., when the user slides ferrule 410 at opening 408 toward opening 430), the inner diameter of braided portion 406 expands to be greater than the outer diameter of float line 400. In this manner, when the braids of the braided hollow core brake assembly is bunched up, float line 400 can freely slide through braided portion 406 of the braided hollow core brake assembly. This state is called the retrieve state and typically exists when the user slides ferrule 410 in the direction +X or slides ferrule 434 or braid end 430 in the direction −X. In use, the spearfisherman may simply hold ferrule 410 in one hand while pulling on float line 400 in the direction −X (thereby essentially causing ferrule 410 to move in the direction +X relative to float line 400) to permit braided portion 406 to bunch up and enlarge, thus allowing float line 400 to slide freely through the interior portion of braided portion 406.

When the fish wishes to run, the movement of float line 400 in the +X direction (since the plug 440 of float line 400 is coupled toward the spear) tends to cause braided portion 406 to elongate if there is some resistance on ferrule 410 (such as the user holding ferrule 410 or ferrule 410 is coupled to a structure such as a float or a boat). The tightening of the inner diameter of braided portion 406 causes the braided hollow core brake assembly to tightly grip float line 400. A braking function is thus activated.

As mentioned, obstruction dimension D1 of transverse obstruction 472 is larger than inner diameter D2 of ferrule 410. Accordingly, plug 450 is inhibited from moving in the direction +X past end 408 of braided portion. This is advantageous since obstruction 472 prevents float line 400 from being pulled through braided portion 406 if there is a force pulling on float line 400 (such as a fish pulling on connector 440 in the direction +X) and braided portion 406 is in the relaxed state.

To shorten assembly 490 (such as in the process of retrieving a speared fish), the user typically holds on to a clip or another suitable structure coupled to attachment point 412. The user then pulls float line 400 in the −X direction to cause braided portion to relax and to slide the entire braided portion 406, including ferrules 410 and 434, in the +X direction. If the fish pulls hard and starts to pull float line 400 in the +X direction relative to braided portion 406, braided portion 406 will grip float line 400 and provides the braking function since the user still holds on to ferrule 410 (via for example a clip or loop of line that is coupled to attachment point 412).

In this manner, a clutching function is provided in that the user can gain float line by sliding braided portion 406 in the direction +X toward plug 440 by holding on to ferrule 410 with one hand while pulling on float line 400 in the direction −X with the other hand. Alternatively, ferrule 410 may be fixed to a structure (such as a float or a boat) and the user simply pulls on float line 400 in the −X direction.

However, when a force pulls on plug 440 in the +X direction, braking is provided by gripping action of braided portion 406 as long as ferrule 410 is not allowed to move in the direction +X. As mention, ferrule 410 may be held by the user or may be attached to a structure such as a float or boat in this situation.

A ring 476 is shown coupled to plug 440 to facilitate attachment to a line coupled to the spear, for example. As it happens, ring 476 is substantially rigid to present another transverse obstruction having a transverse obstruction dimension D3 that is larger than inner diameter D4 of ferrule 434. Thus the transverse obstruction provided by substantially rigid ring 476 prevents float line 400 from being pulled in the direction −X past end 430 of braided portion 406. Other types of transverse obstructions may also be employed instead of ring 476. These transverse obstructions may include pins, an enlarged portion of plug 440, or any mechanical structure that presents a transverse obstruction dimension D3 larger than inner diameter D4 of ferrule 434.

Furthermore, in an embodiment, the transverse obstruction function at one or both ends of the float line 400 may be provided by the coupling(s) employed to couple the plug(s) to the float line (such as by couplings or connectors 454 and 478). As long as this coupling has a larger transverse diameter the inner diameter of the ferrule at its float line end, the obstruction function is accomplished. This is an advantageous embodiment in that each of these couplings can serve a dual function: to couple the plug to the float line and to act as a transverse obstruction to prevent the float line end from being pulled through the braided portion in the manner that causes the unwanted separation of the float line from the braided portion. In another embodiment, the obstruction may be integrated (i.e., machined into or welded to or permanently attached to) the plug if desired.

Once the fish is retrieved, assembly 490 may be reset by sliding ferrule 434 in the −X direction relative to float line 400. This causes braided portion 406 to relax and to slide in the direction −X (relative to float line 400) toward plug 450. In use, this reset action is typically performed by holding ferrule 434 with one hand and pulling on float line 400 in the direction +X with the other hand to allow braided portion 406, including the two ferrules 410 and 434, to slide toward plug 450 (the −X direction in FIG. 4). The reset is complete when ferrule 410 is inhibited by the transverse obstruction from moving further in the direction −X past plug 450 of float line 400.

Note that an attachment point is preferably not provided with ferrule 434 in an embodiment. This is because it is expected that assembly 490 may be looped back on its own by the erratic movement of the fish being retrieved and any potential protrusion on ferrule 434 or coupling 432 may cause unwanted snagging and/or unwanted knotting. This is a particularly advantageous embodiment in that a substantially knot-resistant assembly is obtained with the omission of an attachment protrusion on ferrule 434 or coupling 432 and especially if coupling 432 is made as smooth and small as possible.

In accordance with an embodiment of the invention, a method for manufacturing the innovative float line of FIG. 4 having integrated hollow core brake is provided. Some of the steps described may be performed in different orders as described if desired. First, a resilient and/or flexible float line having a tube shape and having a substantially smooth outer cover is provided. As mentioned, ⅜″ PVC tubing works well in an embodiment. The tubular float line may be provided with an inner core of high strength material if desired. The float line is preferably integrated with end plugs prior to final integration of the integrated hollow core brake assembly.

Next, the braided hollow core brake assembly having a braided portion 406 is provided.

Next, a ferrule 410 is coupled to one end of braided portion 406 and coupled to the end of braided portion 406 using a coupling 420 (which may be a compression ring or clamp or an appropriate knot/string combination or other fastening apparatus). If desired, an optional ferrule 434/ring 432 combination may be coupled to the other end of the braided portion 406. In an embodiment, braided portion 406 may be preassembled with the two ferrules at the two ends of braided portion 406 if desired.

Next, one end of the float line 400 is fed through the ferrule (such as ferrule 410) which is at an opening (such as opening 408 of the example of FIG. 4) of the braided portion 406 of the braided hollow core brake assembly and through the entire interior length of the braided portion 406 and exits through the other opening 430 of the braided portion 406 (and through optional ferrule/ring at this other end if the optional ferrule/ring is provided).

If desired, the float line may be fed in the reverse direction (i.e., from end 430 toward end 408 of braided portion 406. Once float line 400 is threaded through both ends of braided portion 406 (and through the entire interior length of braided portion 406), transverse obstruction/obstructions may be attached to the plug/plugs at one or both ends of the float line to ensure that braided portion 406 and ferrules 410/434 are captured between the transverse obstructions at the ends of the float lines to prevent braided portion 406 from being pulled past either end of the float line 400.

An integrated float line having brake capability is thus formed wherein the braided portion is slidably captured between the two ends of the float line and wherein the float line can be selectively braked by engaging the braided portion.

Although an assembly for fish retrieval is disclosed herein, it should be appreciated that the assembly may be employed for retrieving any load or any mass. The clutching action of the braided portion and the innovative ferrules/obstructions that permit ease of braking/retrieval/resetting while preventing float line/braided portion separation are also advantageous features in these situations. Furthermore, although the inner sliding structure is called a float line in the context of the spearfishing example, the inner sliding structure may in fact represent any flexible structure such as rope, cord, tubing, etc. as long as such inner sliding structure can slide within the interior of the braided portion when the braided portion is relaxed and can be gripped by the braided portion when the braided portion is elongated.

While this invention has been described in terms of several preferred embodiments, there are alterations, permutations, and equivalents, which fall within the scope of the claims of this invention. It should also be noted that there are many alternative ways of implementing the methods and apparatuses of the present invention. Although various examples are provided herein, it is intended that these examples be illustrative and not limiting with respect to the invention.

What is claimed is:

1. An integrated brake-enabled float line assembly, including:
a hollow braided portion having a first braided portion end and a second braided portion end;
a first ferrule coupled to said first braided portion end, said first ferrule having an attachment structure;
a second ferrule coupled to said second braided portion end;
a first plug;
a second plug;
a float line having a first float line end and a second float line end, said first float line end being coupled to said first plug, said second float line end being coupled to said second plug;
a first obstruction coupled to or integrated with said first plug such that a transverse dimension of said first obstruction is larger than an inner diameter of said first ferrule; and
a second obstruction coupled to or integrated with said second plug such that a transverse dimension of said second obstruction is larger than an inner diameter of said second ferrule, whereby said float line is disposed through said hollow braided portion and both said first braided portion end and said second braided portion end and whereby said braided portion is slidably captured between said first plug and said second plug.

2. The integrated brake-enabled float line assembly of claim 1 wherein said first ferrule is formed of stainless steel.

3. The integrated brake-enabled float line assembly of claim 1 wherein said first ferrule is formed of plastic.

4. The integrated brake-enabled float line assembly of claim 1 wherein said first float line is hollow, said float line further includes an internal reinforcing line.

5. The integrated brake-enabled float line assembly of claim 1 wherein said float line represents a hollow plastic tubing.

6. The integrated brake-enabled float line assembly of claim 1 wherein said attachment structure is an enclosed metal loop welded onto said first ferrule.

7. The integrated brake-enabled float line assembly of claim 1 wherein said first obstruction is part of a connection structure, said connection structure being coupled to said first plug via a hole formed in said first plug, said hole being transverse to an axis of said first plug.

8. The integrated brake-enabled float line assembly of claim 7 wherein said connection structure is a shackle.

9. The integrated brake-enabled float line assembly of claim 1 wherein said connection structure is a metal ring.

10. A method of making an integrated brake-enabled float line assembly, including:
providing a hollow braided portion having a first braided portion end and a second braided portion end, said first braided portion end coupled to said first ferrule, said second braided portion end coupled to said second ferrule;
providing a float line having a first float line end and a second float line end, said first float line end is coupled to a first plug, said second float line end is coupled to a second plug; and
disposing said float line through said first ferrule, said hollow braided portion and said second ferrule such that said braided portion is slidably captured between said first plug and said second plug, wherein said first plug is coupled to or integrated with a first obstruction whereby a transverse dimension of said first obstruction is larger than an inner diameter of said first ferrule, said second plug is coupled to or integrated with a second obstruction whereby a transverse dimension of said second obstruction is larger than an inner diameter of said second ferrule.

11. The method of claim 10 wherein said first ferrule is formed of stainless steel.

12. The method of claim 10 wherein said first ferrule is formed of plastic.

13. The method of claim 10 wherein said first float line is hollow, said float line further includes an internal reinforcing line.

14. The method of claim 10 wherein said float line represents a hollow plastic tubing.

15. The method of claim 10 wherein said attachment structure is an enclosed metal loop welded onto said first ferrule.

16. The method of claim 10 wherein said first obstruction is part of a connection structure, said connection structure being coupled to said first plug via a hole formed in said first plug, said hole being transverse to an axis of said first plug.

17. The method of claim 16 wherein said connection structure is a shackle.

18. The method of claim 10 wherein said connection structure is a metal ring.
